(19) United States
(12) Patent Application Publication
(10) Pub. No.: US 2009/0198581 A1
(43) Pub. Date: Aug. 6, 2009

(54) DIGITAL CREATIVE WORKS WIDGETS

(76) Inventor: James M. Lidestri, Hopewell Junction, NY (US)

Correspondence Address: FISH & RICHARDSON P.C., P.O BOX 1022, Minneapolis, MN, 55440-1022, US

(21) Appl. No.: 12/367,276

(22) Filed: Feb. 6, 2009

Related U.S. Application Data
(60) Provisional application No. 61/026,632, filed on Feb. 6, 2008.

(51) Int. Cl. G06Q 30/00; G06F 3/048; G06Q 50/00

(52) U.S. Cl. 705/14; 715/765

(57) ABSTRACT

A computer-implemented method includes generating a profile for a user, the profile having digital creative content associated therewith, and the user having rights in the digital creative content, selecting digital creative content associated with the profile from digital memory, generating a widget in a graphical user interface to advertise the digital creative content, and displaying the digital creative content within the widget based on a criteria selected from a plurality of criteria.

### CROSS-REFERENCE TO RELATED APPLICATIONS

The present application claims priority to U.S. Prov. Pat. App. No. 61/026,632, filed on Feb. 6, 2008, under 35 U.S.C. §119(e). U.S. Prov. Pat. App. No. 61/026,632 is expressly incorporated herein by reference in its entirety for all purposes.

### TECHNICAL FIELD

The present disclosure relates to promoting and/or selling creative works in an online environment, and more particularly to digital widgets for promoting and/or selling creative works in an online environment.

### BACKGROUND

The advent of the Internet has enabled the transfer of information and data to millions of users worldwide. The Internet has also enabled electronic commerce, or e-commerce, which includes the buying and selling of products and/or services over electronic systems such as the Internet, and other computer networks. The amount of electronic trade has rapidly grown over the last decade or so.

Products that are sold through e-commerce can include creative works that are provided in electronic form. Such creative works can include digital writings (e.g., books, papers, articles), digital documents (spreadsheets, databases, files), software applications, audio files, images, photos and videos. Digital creative works can be advertised online through a seller website, for example, and can be electronically transferred to a buyer, upon purchase. Payment for the digital creative works can be made using electronic transfer of funds. Some websites enable users to post their own creative works for sale, or creative works, in which the particular user has rights to post for sale.

### SUMMARY

The present disclosure is directed to computer-implemented methods, computer readable medium, and systems for providing a digital creative works widget. In some implementations, a computer-implemented method includes generating a profile for a user, the profile having digital creative content associated therewith, and the user having rights in the digital creative content, selecting digital creative content associated with the profile from digital memory, generating a widget in a graphical user interface to advertise the digital creative content, and displaying the digital creative content within the widget based on a criteria selected from a plurality of criteria.

In some implementations, the method further includes enabling the user to customize features of the widget, which features correspond to a presentation of the digital creative content within the widget.

In some implementations, the method further includes initiating a purchase of digital creative content through viewer interaction with the widget.

In some implementations, the method further includes generating a multi-level royalty scheme for promotion events related to the digital creative content, and distributing compensation in accordance with the multi-level royalty scheme upon a promotion event initiated through the widget. The compensation can include points that are redeemable in an online environment.

In some implementations, the method further includes enabling a viewer to post a copy of the widget in an online environment. The viewer can be compensated for promotion events that are initiated through the copy of the widget. The viewer compensation can include points that are redeemable in an online environment.

In some implementations, the method further includes generating a summary of the digital creative content, and displaying the summary within the widget.

In some implementations, the method further includes generating a code segment for the widget, and providing the code segment within the widget as a element that can be copied.

In some implementations, the widget displays summary information related to the profile.

In some implementations, the method further includes automatically generating the widget subsequent to generation of the profile, and making the widget available for the user to post in an online environment.

In some implementations, the method further includes modifying display features of the widget, and storing modifications as preferences that are applicable to subsequently generated widgets.

In some implementations, the method further includes providing input options with the widget, wherein a viewer interacts with the widget using the input options. The viewer can input one of ratings, comments and suggestions using one or more input options.

In other implementations, a computer-implemented method of providing a digital creative works widget includes providing an online provider environment, generating a profile associated with the online provider environment for a user having rights in digital creative content, the profile being stored, and associating the digital creative content with the profile. The digital creative content associated with the profile is selected from digital memory, and a widget is displayed in a graphical user interface to advertise the digital creative content. The digital creative content is displayed within the widget based on a criteria selected from a plurality of criteria, and a purchase of digital creative content is initiated through viewer interaction with the widget.

In still other implementations, a computer-implemented method of providing a digital creative works widget includes generating a profile for a user having rights in digital creative content, the profile being stored, associating the digital creative content with the profile, and selecting the digital creative content associated with the profile from digital memory. A widget is generated in a graphical user interface to advertise the digital creative content. The widget is automatically generated upon associating the digital creative content with the profile. The digital creative content is displayed within the widget based on a criteria selected from a plurality of criteria, and the user is able to selectively distribute the widget. A purchase of digital creative content in initiated through viewer interaction with the widget.

A computer readable medium can be encoded with a computer program comprising instructions that, when executed, operate to cause a computer to perform operations in accordance with implementations of the methods of the present disclosure.

A system can include a network, and a computer that communicates over the network. The computer can include a computer-readable medium encoded with a computer program comprising instructions that, when executed, operate to cause a computer to perform operations in accordance with implementations of the methods of the present disclosure.

The details of one or more implementations of the present disclosure are set forth in the accompanying drawings and the description below. Other features, objects, and advantages of the invention will be apparent from the description and drawings, and from the claims.

### DESCRIPTION OF DRAWINGS

FIG. 1 is a functional block diagram of an exemplar system.

FIG. 2A is an illustration of an exemplar provider widget in accordance with implementations of the present disclosure.

FIG. 2B is an illustration of the exemplar provider widget of FIG. 2A in accordance with implementations of the present disclosure.

FIG. 3A is an illustration of an exemplar player widget in accordance with implementations of the present disclosure.

FIG. 3B is an illustration of the exemplar provider widget of FIG. 3A in accordance with implementations of the present disclosure.

FIG. 4 is a flowchart illustrating exemplary steps executed in accordance with implementations of the present disclosure.

### DETAILED DESCRIPTION

The present disclosure is directed to a process for providing one or more digital creative works widgets in a display. A digital creative works widget can include, but is not limited to, a visual arts marketing widget, and is a tool that provides a unique customizable, interactive, portable online marketing application to promote awareness, visibility, collaboration, creation and/or sales and e-commerce for digital content. As used herein, the term widget is directed to a display element that is displayed within a graphical user interface (GUI), that a viewer can interact with to collaborate in creating, to modify digital creative content, and/or to participate in electronic sales and/or distribution of the digital creative content.

The digital creative content can be provided by an artist, an author, a creator of the digital content (e.g., visual content), an agent of the artist/author/creator, and/or any person that has rights in the digital creative works content. As used herein, the term user will be used to describe such a person. The digital creative works content can include, but is not limited to, painting, drawing, printmaking, graphic design, photography, digital writings (e.g., books, papers, articles), digital documents (spreadsheets, databases, files), software applications, audio files, images, photos and videos. Implementations of the widgets of the present disclosure provide an online tool that can be embedded within a visual display, web page, for example, that adds dynamic content for display and possible interaction by users. Dynamic content refers to content that can be added or updated automatically without the need for manual intervention.

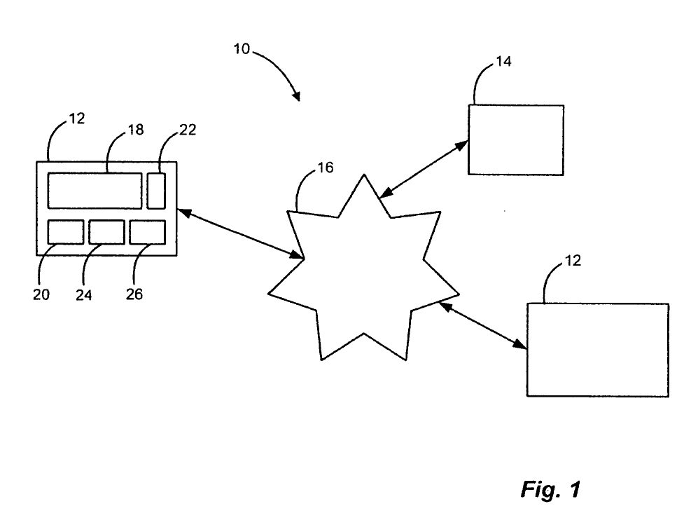

Referring now to FIG. 1, various implementations of the present disclosure can be realized using computer systems and computer programs. An exemplar computer network 10 includes a plurality of computers 12, and one or more servers 14 that communicate with one another over a network 16. The network 16 can include, but is not limited to, a local area network (LAN), a wide area network (WAN), and/or the Internet. An exemplar computer 12 includes a display 18, an input device 20, such as a keyboard and/or mouse, memory 22, a dataport 24, and a central processing unit (CPU) 26. The display 18 can include a CRT (cathode ray tube) or LCD (liquid crystal display) monitor for displaying information to the user. The input device 20 can include a keyboard, and/or a pointing device such as a mouse or a trackball, by which the user can provide input to the computer 12. Other kinds of devices can be used to provide for interaction with a user as well; for example, input from the user can be received in any form, including acoustic, speech, or tactile input.

A software program, or computer program product that executes one or more implementations of the method of the present disclosure, can be resident on one or more of the computers 12, and/or on the server 14. For example, the software program can be resident on a particular computer 12, which the user implements to define a widget, discussed in further detail below, and generate the corresponding code. Additionally, or in the alternative, the user can access a website through the network 16. The widget can be defined, and the code for the widget can be generated through the website interface. It is also contemplated that code can be generated for implementations of the widget to be displayed in mobile devices including, but not limited to, cellular telephones, smartphones, and personal digital assistants (PDAs).

In various implementations of the present disclosure, a provider and/or user selects the content to be highlighted on the widget. The content can be from one or more locations including, but not limited to, a local computer system, a local area network (LAN), a wide area network (WAN), and/or websites that are accessible via the Internet. In fact, the content can be provided from any device described herein. The content can include, but is not limited to, still images, video clips, audio files, textual information, data elements, digital writings (e.g., books, papers, articles), digital documents (spreadsheets, databases, files), software applications, and photos. Furthermore, the content can contain samples (e.g., photos, videos), information (e.g., titles, descriptions, categories, tags/search terms, ratings, views/usage, comments, creation/add/modification dates, location, creator(s) names, creator(s) biographies, specifications (e.g., sizes, materials used, quality characteristics, etc.), sales data, price(s), etc.), provider information (e.g., name, address, phone, e-mail, provider type, agent name and contact, biography, news, add/modification dates, ratings, views/usage, comments, sales data), and/or viewer information (e.g., names, biography, news, add/modification dates, stored visual art information, and/or stored provider information).

The provider and/or user can select the manner, in which the widget presents the content. The content can be presented in part, or in entirety, and can be selectively pre-sorted for the viewer by various criteria. Exemplar criteria can include, but is not limited to, creation date, add date, modification date, rating, views or usage, price, sales numbers (e.g., units and/or total revenue), comment date, news date, artist/author/creator name, title, categories, name, type, provider add date, provider modification date, provider rating, provider views or usage, provider sales numbers (e.g., units and/or total revenue), provider news date, provider comment date, viewer name, viewer add date, viewer modification date, viewer visual art information, and/or viewer information provider information.

Software code is generated to provide one or more widgets in accordance with the provider's specifications. The provider, user, and/or a viewer can utilize the generated code to embed the widget on a webpage for viewing. The generated code can include, but is not limited to, hyper-text mark-up language (HTML) code. The generated code can enable the widget to be run on various devices including, but not limited to, mobile devices (e.g., laptops, cell phones, PDAs, tablet laptops, and/or other mobile devices), as well as various other consumer electronics devices (e.g., computers, set top boxes, DVR's, media terminals, TV control devices, gaming consoles, and/or home automation systems). For example, the generated code can be embedded in a mobile device such that the widget can be operated via the mobile device. As another example, the generated code can be embedded in a consumer electronics device such that the widget can be operated via the consumer electronic device.

In other implementations, the provider and/or user can be presented with a set of standard widgets of content selections and presentations from which to select, as well as with associated codes. The provider and/or user may also be able to customize the standard widgets, after which code for the customized widget is generated.

The widget can enable a viewer to view a preview of a sample of the digital content. The widget can also enable the viewer to change the manner in which the selected content is presented. For example, the user can select which items to display and how those items are to be presented. The widget can provide a search and/or refinement capability to generate customized views of content and presentation from the provider. The widget can provide the viewer with the ability to save stored preference criteria such that the widget can dynamically present a customized view of content and presentation upon future views.

In implementations of the present disclosure, the widget can enable the viewer to add digital content to the widget, and to modify the presentation of the content within the widget. In this manner, the viewer can execute functions similar to those executed by the provider and/or user. In some implementations, the viewer can apply a filter, which adjusts the presentation of the content. Exemplar filters can include, but are not limited to, title, categories, ratings, views/usage, creation/add/modification dates, location, artist(s) names, and price. Furthermore, code can be automatically generated for the viewer customized widget, which can be provided to other providers and/or viewers.

In implementations of the present disclosure, the widget enables the viewer to initiate a purchase of the digital content. The widget can provide the viewer with the code that may be necessary to re-embed the widget on another webpage. Further, the widget can enable the viewer to share the widget with selected contacts using individually entered e-mail addresses, phone numbers, device ID's, and/or contacts that are pulled from a central address book of the viewer. In general, the widget, as well as downstream copies of the widget that can be posted by viewers, enable promotion events to occur through viewer interaction with the widget. As used herein, the term promotion event includes, but is not limited to, viewing of the digital creative content, rating the digital creative content, a sale of the digital creative content, and/or a per click count corresponding to the digital creative content.

In implementations of the present disclosure, the widget can dynamically display the digital creative content based on usage information, such as views, ratings, sales, and the like. Further, a detailed set of usage and/or sales reports generated from the widget can be provided to the provider, the user and/or the viewer.

It is further contemplated that the provider can set up a royalty scheme to compensate viewers in order to aid in the sale and/or promotion of digital creative content. The viewer can also be enabled to receive royalties for sales and/or promotion of digital creative content that are generated from widgets that the viewer embeds on a downstream webpage, for example. Further, a royalty scheme can be set up to compensate providers that aid in the sale and/or promotion of digital creative content. The provider can receive royalties for sales or promotion of the digital creative content that are generated from widgets that the provider embeds on a webpage. In other implementations, a multi-level royalty scheme can be arranged such that providers and/or viewers, which embed widgets that result in sales of the digital creative content, will be compensated for sales generated from their embedded widget, as well as any downstream viewer digital creative content sales. For example, Provider A's widget can generates X sales. Viewer B, who sees Provider A's widget, re-embeds that Widget, or a customized version of it, generates Y sales. Viewer C uses Viewer B's widget and generates Z sales. In this case, Provider A can be compensated for X+Y+Z sales; Viewer B can be compensated for Y+Z sales, and Viewer C can be compensated for Z sales. The multi-level royalty scheme can be arranged in any manner desired. Exemplar royalty schemes that can be implemented are described in co-pending U.S. patent application Ser. No. 12/354,961, filed on Jan. 16, 2009, the disclosure of which is expressly incorporated herein by reference in its entirety. Compensation can include, but is not limited to monetary, credit, and/or points that are redeemable in an online environment.

The widget itself can also be customized. For example, titles, title effects (e.g., wipes, fades, etc.), text, text effects (e.g., fonts, sizes, colors, underline, bold, shadow, etc.), graphics, and/or graphic effects (e.g., place images, graphics, backgrounds, themes, etc.) can be added. Photo effects (e.g., soften, blur, contrast, sepia, hue, saturation, etc.) can also be applied. Further, the image or images can be re-oriented (e.g., rotate, zoom in and out), and/or slideshow effects can be applied (e.g., the nature of the way the images transition to one another). The user-defined options can be saved for future use.

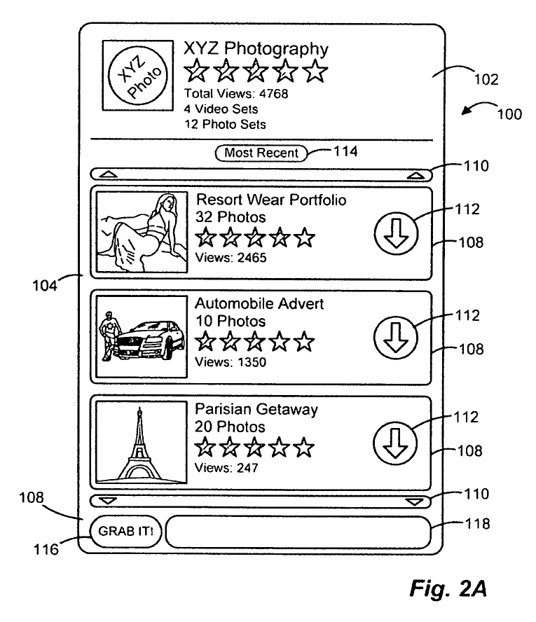

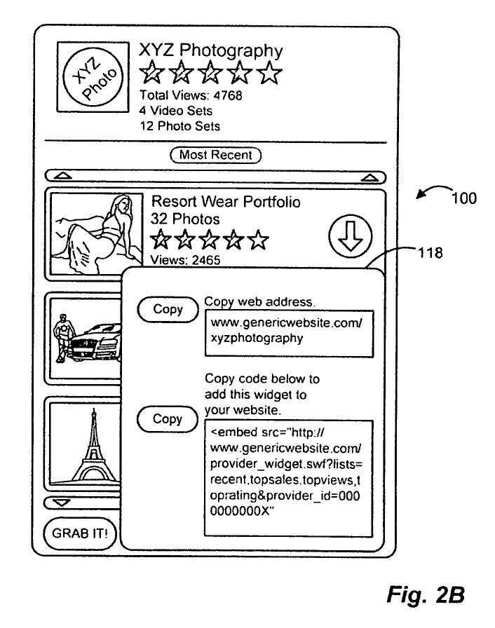

Referring now to FIGS. 2A and 2B, an exemplar provider widget 100 will be described. In the exemplar implementation, the provider can include a website proprietor who provides an online environment (e.g., “www.genericwebsite.com”) for a user to exhibit and/or offer for sale digital content. For example, the user can create a profile on the provider's website, and can upload digital content to the website. An exemplar profile is described in U.S. patent application Ser. No. 12/355,280, filed on Jan. 16, 2009, the disclosure of which is expressly incorporated herein by reference in its entirety. The user can access the profile through the provider's website, and can build a collection of digital content associated with the profile. By way of one non-limiting example, the digital content can include one or more photo sets, each of which includes one or more photographs provided as digital photographs. By way of another non-limiting example, the digital content can also, or alternatively include one of more videos, and/or video sets. Each video set can include one or more still images that have been captured from a corresponding video. The provider widget 100 is automatically generated upon generation and population of the user profile. More specifically, after the user creates the profile, and uploads digital content including, but not limited to, a video set and/or a photo set, the provider widget 100 is generated to showcase, or otherwise market the user profile and/or content.

With particular reference to FIG. 2A, the exemplar provider widget 100 includes a summary section 102, a content section 104, and a share section 106. The summary section 102 can include information associated with the particular user. For example, the information can include, but is not limited to, the user's name (e.g., “XYZ Photography”), a user thumbnail (e.g., including a sample photo, and/or a logo associated with the user), a user rating (e.g., 3.5/5 stars), a total number of views of the user's content (e.g., “Total Views: 4768”), and/or a total number of sets associated with the user's profile (e.g., “4 Video Sets” and “12 Photo Sets”). The content section 104 includes summary blocks 108 corresponding to the content stored to the user's profile. The summary blocks 108 can correspond to each of the content sets stored to the user's profile, or a sub-set of such content, as explained in further detail below. Scroll bars 110 are provided to enable a viewer to scroll through the summary blocks 108. For example, although a limited number of summary blocks 108 (e.g., three in the instant example) can be displayed within the content section 104, a viewer can scroll through the summary blocks 108 to view other available summary blocks 108.

Each summary block 108 provides a sub-set of information associated with a particular content set. The sub-set of information can include, but is not limited to, a thumbnail image associated with the content set, a title of the content set (e.g., “Resort Wear Portfolio,” “Automobile Advert,” or “Parisian Getaway” in the instant example), the number of images, or photos in the particular content set (e.g., “32 Photos,” “10 Photos,” or “20 Photos” in the instant example), a content set rating (e.g., 4/5 stars, or 3/5 stars in the instant example), and the number of times the particular set has been viewed (e.g., “Views: 2465,” “Views: 1350,” or “Views: 247: in the instant example). It is contemplated that the particular information can be determined by the provider, and/or the user can modify and select which information is displayed in the summary block 108. A download icon 112 can also be provided in each summary block 108, which enables a viewer to initiate a digital transfer of the user's content. For example, a viewer can click on the download icon 112 to initiate a sale of the particular digital content, which digital content is subsequently downloaded to a viewer location (e.g., a hard drive associated with a device, from which the viewer is viewing the provider widget) upon completion of the sale. A royalty scheme, discussed above, can be applied to such a sale.

A filter can be applied to arrange the presentation of the content sets. More specifically, by clicking on a filter button 114, a user can apply a chosen filter to arrange the summary blocks 108 in a corresponding order. In the exemplar illustration of FIG. 2A, a “Most Recent” filter is applied, through which the summary blocks 108 are arranged in order of the content most recently added to the user's profile. In the exemplar illustration of FIG. 2A, the content set “Resort Wear Portfolio” was added to the user's profile before the content set “Automobile Advert,” which was added to the user's profile before the content set “Parisian Getaway.” Other filters can be selected. Exemplar filters include, but are not limited to, title (e.g., alphabetical), categories, ratings, views/usage, creation/add/modification dates, location, artist(s) names (e.g., alphabetical), and price (e.g., increasing, or decreasing).

The share section 106 can include a clickable icon 116 and a window 118. More specifically, when a viewer clicks on the clickable icon 116 (e.g., “Grab It!” in the instant example), the window expands 118, for example, as seen in FIG. 2B. The expanded window 118 provides options for sharing information on the user, and/or for electronically distributing the provider widget 100 to other websites. More specifically, the expanded window 118 can include a uniform resource locator (URL) associated with the user's profile on the provider's website. In the exemplar implementation of FIG. 2B, the URL is provided as “www.genericwebsite.com/xyzphotography.” It is appreciated that this URL is merely exemplar in nature. In this manner, a viewer can copy and paste the URL to any location the viewer desires, such that downstream viewers can be directed to the user's profile on the provider's website by clicking on the URL.

The expanded window 118 can also include a code segment (e.g., HTML code) associated with the provider widget 100. In the exemplar implementation of FIG. 2B, the code segment is provided as “<embed src=“http://www.genericwebsite.com/provider_widget.swf?lists=recent,topsales,topviews,toprating&provider_id=0000000000X”.” It is appreciated that this code segment is merely exemplar in nature. In this manner, a viewer can copy and paste the code segment into another website to display the provider widget 100 in the other website. For example, the viewer can post the particular provider widget 100 to another profile associated with a social networking website, by pasting the particular code segment to a page on the social networking website. In this manner, the particular provider widget 100 is viewable to members of the social networking website. Consequently, the particular provider widget 100 can be distributed across any number of websites, which increases the exposure of the user (e.g., XYZ Photography, in the instant example), and/or increases the chance of selling the content associated with the user.

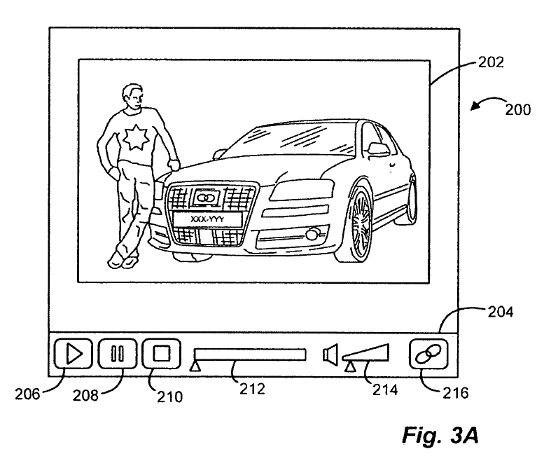

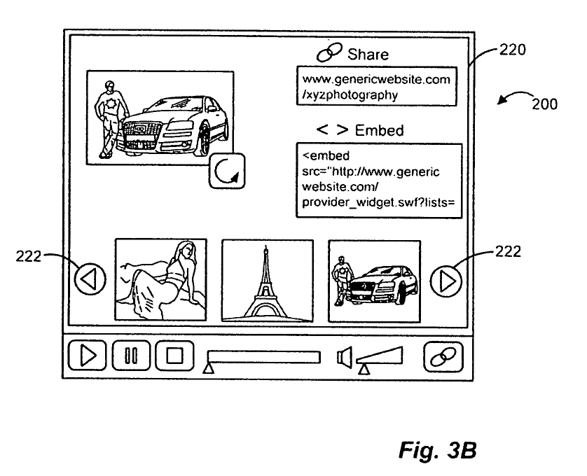

Referring now to FIGS. 3A and 3B, an exemplar player widget 200 will be described. In the exemplar implementation, the content displayed in the player widget 200 is provided from the provider through the user's profile. As discussed above, such a provider can include a website proprietor that provides an online environment (e.g., “www.genericwebsite.com”) for a user to exhibit and/or offer for sale digital content. By way of one non-limiting example, the digital content can include one or more photo sets, each of which includes one or more photographs provided as digital photographs. By way of another non-limiting example, the digital content can also, or alternatively include one of more videos, and/or video sets. Each video set can include one or more still images that have been captured from a corresponding video. The player widget 200 is automatically generated upon generation and population of the user profile within the provider system. More specifically, after the user creates the profile, and uploads digital content including, but not limited to, a video set and/or a photo set, the player widget 200 is generated to showcase, or otherwise market the user profile and/or content.

With particular reference to FIG. 3A, the player widget 200 can include a display block 202 and a control block 204. The display block 202 displays a selected content set, and the control block 204 enables a viewer to dynamically view the content set. More specifically, the control block 204 can include controls that enable the viewer to manipulate viewing of the content set. The controls illustrated in the exemplar implementation of FIG. 3A include, but are not limited to, a play button 206, a pause button 208, a stop button 210, a counter bar 212, volume control 214, and a share button 216. In the case where the content includes a video, the video can be played by clicking the play button 206, can be paused by clicking the pause button 208, can be stopped by clicking the stop button 210, the viewer can forward and reverse through the video using the counter bar 212, and the viewer can adjust a volume using the volume control 212. In the case where the content include a photo set, a slideshow of the photo set, or a sub-set of the photos, can be played by clicking the play button 206, can be paused by clicking the pause button 208, can be stopped by clicking the stop button 210, and the viewer can forward and reverse through the slideshow using the counter bar 212. It is also contemplated that the viewer can adjust a volume 214 using the volume control, in the case where sound (e.g., music and/or commentary) is included with the photo set. Although content including video and/or photos has been described in the exemplar implementation, it is contemplated that the content viewable using the player widget 200 can include any type of content.

The share button 216 enables a viewer to view additional content associated with the particular user, and to share the user's profile and/or the player widget 200 with others. More specifically, by clicking on the share button 216, the display block 202 adjusts to provide a content selection and sharing block. An exemplar content selection and sharing block 220 is illustrated in FIG. 3B, which includes a thumbnail of the just viewed content, a series of thumbnails of other content the user has stored to their profile, and options for sharing information on the user, and/or for electronically distributing the player widget to other websites. More specifically, the share options can include a uniform resource locator (URL) associated with the user's profile on the provider's website. In the exemplar implementation of FIG. 3B, the URL is provided as “www.genericwebsite.com/xyzphotography.” It is appreciated that this URL is merely exemplar in nature. In this manner, a viewer can copy and paste the URL to any location the viewer desires, such that downstream viewers can be directed to the user's profile on the provider's website by clicking on the URL.

The share options can also include a code segment (e.g., HTML code) associated with the player widget. In the exemplar implementation of FIG. 3B, the code segment is provided as “<embed src=“http://www.genericwebsite.com/provider_widget.swf?lists=recent,topsales,topviews,toprating&provider_id=0000000000X”,” although the entire code segment is not illustrated. It is appreciated that this code segment is merely exemplar in nature. In this manner, a viewer can copy and paste the code segment into another website to display the player widget 200 in the other website. For example, the viewer can post the particular player widget 200 to another profile associated with a social networking website, by pasting the particular code segment to a page on the social networking website. In this manner, the particular player widget 200 is viewable to members of the social networking website. Consequently, the particular player widget 200 can be distributed across any number of websites, which increases the exposure of the user (e.g., XYZ Photography, in the instant example), and/or increases the chance of selling the content associated with the user.

The series of thumbnails enables a viewer to scroll through the content that is associated with the user's profile. Scroll buttons 222 are provided to enable a viewer to scroll through the thumbnails. For example, although a limited number of thumbnails (e.g., three in the instant example) can be displayed, a viewer can use the scroll the thumbnails to view other available thumbnails. By clicking on a thumbnail, the player widget 200 expands the thumbnail and enables the viewer to view the content in the display block 202, as illustrated in FIG. 3A, for example.

In some implementations, the provider widget 100 and the player widget 200 can be combined into a single content widget. For example, the content widget can be initially displayed as seen in FIG. 2A. By clicking on a summary block 108, the content widget can display the particular content for slideshow display, as seen in FIG. 3A. Using the exemplar illustrations of FIGS. 2A and 3A, if the viewer clicks on the summary block 108 for the content “Automobile Advert,” the content widget provides the player display of FIG. 3A, which the viewer can use to view a slideshow the “Automobile Advert” content set. It is contemplated that any and all of the functionality of the provider widget 100 and the player widget 200 can be combined to provide a single content widget having characteristics of each.

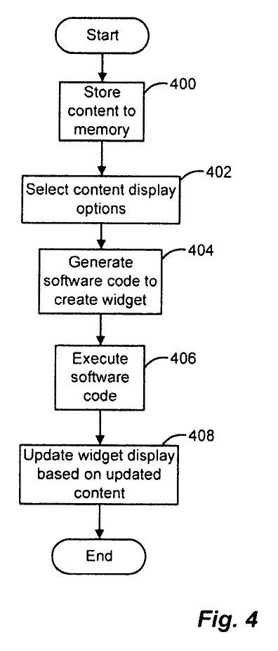

Referring now to FIG. 4, exemplar steps that can be executed in implementations of the present disclosure will be described. In step 400, content is stored to memory. In step 402, content display options are selected. Software code for creating a widget are generated in step 404, and the software code is executed in step 406 to display the widget. In step 408, the widget is updated based on updated content. For example, in the case where a user adds content to their user profile, the added content is updated to the widget.

The present disclosure can be implemented in digital electronic circuitry, or in computer hardware, firmware, software, or in combinations thereof. The present disclosure can be implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Implementations of the present disclosure can be performed by one or more programmable processors executing a computer program to perform functions of the invention by operating on input data and generating output. Processes can also be performed by, and apparatus can be implemented as, special purpose logic circuitry, e.g., an FPGA (field programmable gate array) or an ASIC (application-specific integrated circuit). Processors suitable for the execution of a computer program include, by way of example, both general and special purpose microprocessors, and any one or more processors of any kind of digital computer. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks. The processor and the memory can be supplemented by, or incorporated in special purpose logic circuitry.

Processes of the present disclosure can be implemented in a computing system that includes a back-end component, e.g., as a data server, or that includes a middleware component, e.g., an application server, or that includes a front-end component, e.g., a client computer having a graphical user interface or an Web browser through which a user can interact with an implementation of the invention, or any combination of such back-end, middleware, or front-end components. The components of the system can be interconnected by any form or medium of digital data communication, e.g., a communication network. Examples of communication networks include a local area network, a wide area network, and the Internet.

A number of implementations have been described. Nevertheless, it will be understood that various modifications may be made without departing from the spirit and scope of the disclosure. More specifically, implementations of the method and system of the present disclosure can include various combinations of the features described herein. For example, implementations of the method and system can include a plurality of the features described herein, while other implementations can include all of the features described herein.

What is claimed is:

1. A computer-implemented method of providing a digital creative works widget, comprising:
generating a profile for a user, the profile having digital creative content associated therewith, and the user having rights in the digital creative content;
selecting digital creative content associated with the profile from digital memory;
generating a widget in a graphical user interface to advertise the digital creative content; and
displaying the digital creative content within the widget based on a criteria selected from a plurality of criteria.

2. The method of claim 1, further comprising enabling the user to customize features of the widget, which features correspond to a presentation of the digital creative content within the widget.

3. The method of claim 1, further comprising initiating a purchase of digital creative content through viewer interaction with the widget.

4. The method of claim 1, further comprising:
generating a multi-level royalty scheme for promotion events related to the digital creative content; and
distributing compensation in accordance with the multi-level royalty scheme upon occurrence of a promotion event initiated through the widget.

5. The method of claim 4, wherein the compensation includes points that are redeemable in an online environment.

6. The method of claim 1, further comprising enabling a viewer to post a copy of the widget in an online environment, wherein the viewer can be compensated for promotion events that are initiated through the copy of the widget.

7. The method of claim 6, wherein viewer compensation includes points that are redeemable in an online environment.

8. The method of claim 1, further comprising:
generating a summary of the digital creative content; and
displaying the summary within the widget.

9. The method of claim 1, further comprising:
generating a code segment for the widget; and
providing the code segment within the widget as a element that can be copied.

10. The method of claim 1, wherein the widget displays summary information related to the profile.

11. The method of claim 1, further comprising:
automatically generating the widget subsequent to generation of the profile; and
making the widget available for the user to post in an online environment.

12. The method of claim 1, further comprising:
modifying display features of the widget; and
storing modifications as preferences that are applicable to subsequently generated widgets.

13. The method of claim 1, further comprising providing input options with the widget, wherein a viewer interacts with the widget using the input options.

14. The method of claim 13, wherein the viewer can input one of ratings, comments and suggestions using one or more input options.

15. A computer-implemented method of providing a digital creative works widget, comprising:
providing an online provider environment;
generating a profile associated with the online provider environment for a user having rights in digital creative content, the profile being stored;
associating the digital creative content with the profile;
selecting the digital creative content associated with the profile from digital memory;
generating a widget in a graphical user interface to advertise the digital creative content;
displaying the digital creative content within the widget based on a criteria selected from a plurality of criteria; and
initiating a promotion event relating to the digital creative content through viewer interaction with the widget.

16. The method of claim 15, further comprising enabling the user to customize features of the widget, which features correspond to a presentation of the digital creative content within the widget.

17. The method of claim 15, further comprising:
generating a multi-level royalty scheme for purchases of digital creative content; and
distributing compensation in accordance with the multi-level royalty scheme upon occurrence of the promotion event.

18. The method of claim 15, further comprising enabling a viewer to distribute a copy of the widget, wherein the viewer can be assigned a portion of proceeds generated upon the promotion event being initiated through the copy of the widget.

19. The method of claim 15, further comprising:
modifying display features of the widget; and
storing modifications as preferences that are applicable to subsequently generated widgets.

20. A computer-implemented method of providing a digital creative works widget, comprising:
generating a profile for a user having rights in digital creative content, the profile being stored;
associating the digital creative content with the profile;
selecting the digital creative content associated with the profile from digital memory;
generating a widget in a graphical user interface to advertise the digital creative content, wherein the widget is automatically generated upon associating the digital creative content with the profile;
displaying the digital creative content within the widget based on a criteria selected from a plurality of criteria;
enabling the user to selectively distribute the widget; and
initiating a purchase of digital creative content through viewer interaction with the widget.
